(19) United States
(12) Patent Application Publication
(10) Pub. No.: US 2024/0104597 A1
(43) Pub. Date: Mar. 28, 2024

(54) INCENTIVE GRANTING METHOD AND RECORDING MEDIUM

(71) Applicant: Panasonic Intellectual Property Management Co., Ltd., Osaka (JP)

(72) Inventors: Akihiko IGUCHI, Osaka Fu (JP); Fumio KOSUGE, Osaka Fu (JP)

(73) Assignee: Panasonic Intellectual Property Management Co., Ltd., Osaka (JP)

(21) Appl. No.: 18/521,471

(22) Filed: Nov. 28, 2023

Related U.S. Application Data
(63) Continuation of application No. PCT/JP2022/015194, filed on Mar. 28, 2022.

(30) Foreign Application Priority Data
Jun. 30, 2021 (JP) 2021-109144

(51) Int. Cl. G06Q 30/0207; G06Q 10/02; G06Q 30/0283

(52) U.S. Cl. CPC G06Q 30/0223; G06Q 10/02; G06Q 30/0215; G06Q 30/0239; G06Q 30/0284; G06Q 10/06312

(57) ABSTRACT

An incentive granting method is implemented by a parking lot management system in which incentive information is stored. The incentive information is associated with a parking section. The method is executed to grant an incentive indicated by the incentive information to a user who uses a parking section associated with the incentive information. The method includes displaying pieces of incentive information associated with multiple parking sections on a display terminal connected to the parking lot management system via a network. The method includes detecting a vehicle parked in one of the multiple parking sections. The vehicle matches vehicle information registered in association with account information of the user. The method includes applying, to the account information at predetermined timing, an incentive indicated by one of the pieces of incentive information associated with the one of the multiple parking sections.

### CROSS-REFERENCE TO RELATED APPLICATIONS

This application is a continuation of International Application No. PCT/JP2022/015194, filed on Mar. 28, 2022, which claims the benefit of priority of the prior Japanese Patent Application No. 2021-109144, filed on Jun. 30, 2021, the entire contents of which are incorporated herein by reference.

### FIELD

The present disclosure relates generally to an incentive granting method and a recording medium.

### BACKGROUND

In a case where a vehicle is parked in a large parking lot provided with a large commercial facility or the like, a specific parking section associated with incentive information is notified to a user to alleviate congestion in the parking lot. When the user parks in the parking section, an incentive indicated by the incentive information associated with the parking section is applied to the user (for example, JP 2020-129248 A).

Under such circumstances, there is a demand for improving the degree of freedom of the user to select a parking section.

### SUMMARY

An incentive granting method according to an embodiment is implemented by a parking lot management system in which full/vacancy information and incentive information are stored. The full/vacancy information indicates a parking section being vacant in a parking lot. The incentive information is associated with the parking section. The incentive granting method is executed to grant an incentive indicated by the incentive information to a user who uses a parking section associated with the incentive information. The incentive granting method includes displaying pieces of incentive information associated with multiple parking sections on a display terminal connected to the parking lot management system via a network. The incentive granting method includes detecting a vehicle parked in one of the multiple parking sections. The vehicle matches vehicle information registered in association with account information of the user. The incentive granting method includes applying, to the account information at predetermined timing, an incentive indicated by one of the pieces of incentive information associated with the one of the multiple parking sections.

### BRIEF DESCRIPTION OF THE DRAWINGS

FIG. 1 is a block diagram illustrating an example of a configuration of an incentive granting system according to an embodiment;

FIG. 2 is a diagram illustrating an example of functional blocks of the incentive granting system according to the embodiment;

FIG. 3 is a diagram illustrating an example of a display form of incentive information according to the embodiment;

FIG. 4 is a diagram illustrating an example of a display form of incentive information according to the embodiment;

FIG. 5 is a diagram illustrating an example of a display form of updated incentive information according to the embodiment;

FIG. 6 is a diagram illustrating an example of a display form of updated incentive information according to the embodiment;

FIG. 7 is a diagram illustrating an example of a display form of updated incentive information according to the embodiment;

FIG. 8 is a diagram illustrating an example of a display form of pieces of incentive information according to the embodiment;

FIG. 9 is a sequence diagram illustrating an example of a procedure of information processing executed in the incentive granting system according to the embodiment;

FIG. 10 is a diagram illustrating an example of a display form of information regarding parking section selection according to the embodiment;

FIG. 11 is a diagram illustrating an example of a display form of incentive information after a parking section reservation according to the embodiment;

FIG. 12 is a diagram illustrating an example of a display form of information regarding completion of the reservation of parking section according to the embodiment;

FIG. 13 is a diagram illustrating an example of a display form of information notifying incentive granting according to the embodiment; and

FIG. 14 is a sequence diagram illustrating an example of a procedure of information processing executed in the incentive granting system according to the embodiment.

### DETAILED DESCRIPTION

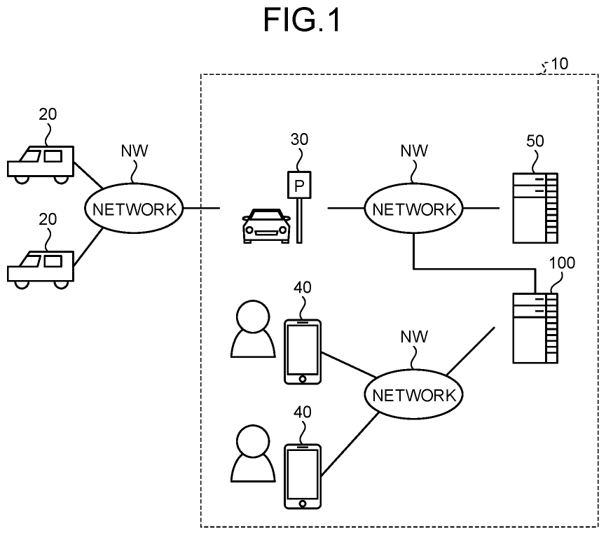

Hereinafter, an incentive granting method and an incentive display program according to the present disclosure will be described with reference to FIGS. 1 to 14. Configuration of incentive granting system 10

A configuration of an incentive granting system 10 according to an embodiment will be described with reference to FIG. 1. FIG. 1 is a block diagram illustrating an example of the configuration of the incentive granting system 10 according to the embodiment.

As illustrated in FIG. 1, the incentive granting system 10 includes a parking lot 30, a display terminal 40, an incentive generation server 50, and a parking lot management system 100. The parking lot 30, the display terminal 40, the incentive generation server 50, and the parking lot management system 100 communicate with each other via a communication network NW.

In addition, the parking lot management system 100 communicates with a vehicle 20 via the communication network NW. The communication network NW is a mobile phone network having a large number of base stations as terminals, a satellite communication network using communication satellites, and so forth.

In the parking lot management system 100 in which full/vacancy information indicating a vacant parking section in the parking lot 30 and incentive information associated with a parking section are stored, the incentive granting system 10 executes granting of an incentive indicated by the incentive information to a user who uses the parking section associated with the incentive information. The incentive information associated with the parking section of the parking lot 30 is displayed on the display terminal 40, which is owned by the user and connected to the parking lot management system 100 via the network. When the vehicle 20 being parked in the parking section is detected, the parking lot management system 100 determines to apply an incentive to account information of the user of the vehicle 20. The incentive to be applied is indicated by the incentive information associated with the parking section in which the vehicle 20 is parked. The incentive is applied to the account information of the user at predetermined timing. Note that the vehicle 20 registered in association with the account information of the user is, for example, a vehicle owned by the user, but is not limited thereto. For example, the user may register a vehicle on which the user rides, such as a vehicle of a family member or a friend, or may register a vehicle that is temporarily or intermittently used by using a rental car, car sharing, or the like.

Specifically, the incentive generation server 50 acquires parking lot usage data generated on the basis of image data of the parking lot captured by an infrastructure camera, and generates the incentive information on the basis of the acquired parking lot usage data. The parking lot management system 100 acquires the incentive information and generates parking lot information on the basis of the acquired incentive information. The parking lot information is generated to include the incentive information, the full/vacancy information, and parking lot congestion information. The parking lot information is provided to an application executed on the display terminal 40 owned by the user at predetermined timing.

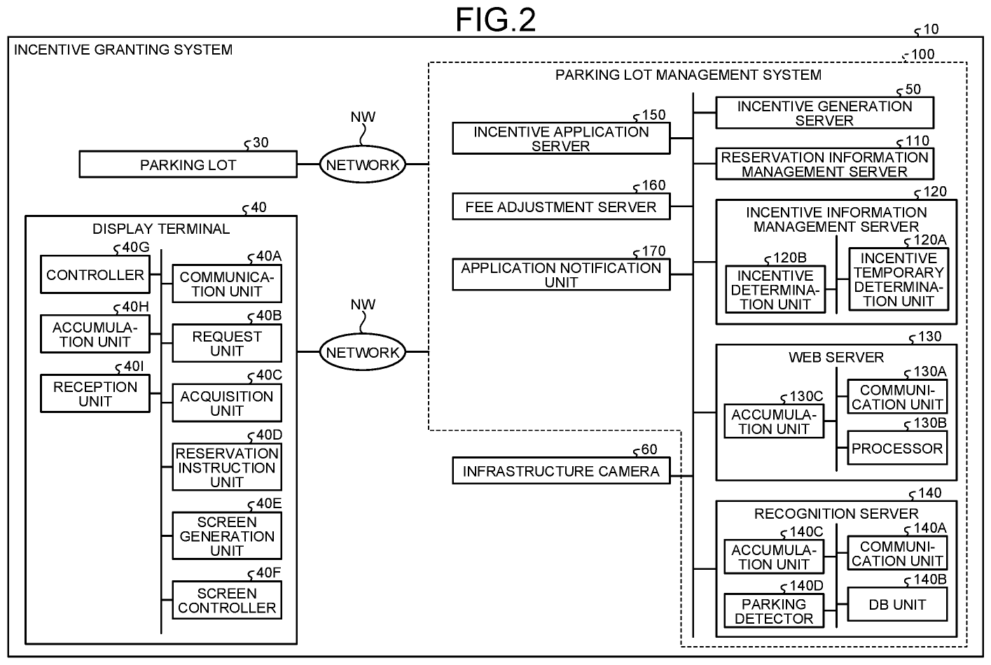

Next, functions of the incentive granting system 10 according to an embodiment will be described with reference to FIG. 2. FIG. 2 is a diagram illustrating an example of functional blocks of the incentive granting system 10 according to the embodiment.

Configuration of Display Terminal 40

The display terminal 40 is owned by the user and displays incentive information associated with a parking section. In the present embodiment, the display terminal 40 displays information indicating that an incentive has been applied. The display terminal 40 is an example of an information display device. In the present embodiment, a portable information terminal such as a smartphone or a tablet will be described in one example of the display terminal 40.

The display terminal 40 has, as a functional configuration, a communication unit 40A, a request unit 40B, an acquisition unit 40C, a reservation instruction unit 40D, a screen generation unit 40E, a screen controller 40F, a controller 40G, an accumulation unit 40H, and a reception unit 40I.

The communication unit 40A transmits and receives information to and from the parking lot management system 100. For example, the communication unit 40A receives the parking lot information including the full/vacancy information, the parking lot congestion information, and the incentive information, from the parking lot management system 100 via a known communication line such as a mobile phone network.

The request unit 40B requests the parking lot management system 100 for the parking lot information regarding the parking lot 30, which includes the full/vacancy information, the parking lot congestion information, and the incentive information.

The acquisition unit 40C acquires the parking lot information including the full/vacancy information, the parking lot congestion information, and the incentive information requested by the request unit 40B, from a WEB server 130 of the parking lot management system 100. In one example, the acquisition unit 40C does not acquire information already stored in the accumulation unit 40H from the WEB server 130. Note that, when acquiring the parking lot information from the WEB server 130, the acquisition unit 40C may acquire information that includes information already stored in the accumulation unit 40H.

The reservation instruction unit 40D transmits, to the parking lot management system 100, an instruction to set the parking section selected via the reception unit 40I as a parking section reserved by the user.

The screen generation unit 40E generates an image to be displayed on a display device of the display terminal 40.

The screen controller 40F outputs the image generated by the screen generation unit 40E to the display device of the display terminal 40. In other words, the screen controller 40F displays the image to the user with the display device of the display terminal 40. For example, the screen controller 40F displays an image showing the incentive information to the user.

The controller 40G controls the communication unit 40A, the request unit 40B, the acquisition unit 40C, the reservation instruction unit 40D, the screen generation unit 40E, the screen controller 40F, the accumulation unit 40H, and the reception unit 40I on the basis of the information acquired by the display terminal 40.

The accumulation unit 40H accumulates the information acquired by the display terminal 40. The accumulation unit 40H accumulates, for example, the incentive information.

The reception unit 40I receives an input of an instruction or information from the user.

In the present embodiment, while a portable information terminal such as a smartphone is described in one example of the display terminal 40, the display terminal 40 may be directly connected to a navigation device 70 mounted on the vehicle 20, or may be connected via a network. Examples of such a display terminal 40 directly connected to the navigation device 70 include an in-vehicle display device serves as a car navigation system.

The incentive display program is provided as an application program executed by the display terminal 40. The incentive display program is executed by the display terminal 40 that is provided with a screen display. The display terminal 40 is connected to the parking lot management system 100 via a network. The parking lot management system 100 stores the full/vacancy information indicating a vacant parking section in the parking lot 30 and incentive information associated with the parking section. The incentive display program causes the display terminal 40 to acquire pieces of incentive information associated with multiple parking sections and to execute an operation of displaying the acquired incentive information on the display. The incentive display program also causes the display terminal 40 to execute an operation of displaying information indicating that the incentive indicated by the incentive information has been applied on the display. The operation of displaying is executed when the incentive information determined to be given is applied to the account information at predetermined timing. In addition, the granting of the incentive is determined in response to the vehicle 20 matching the vehicle information registered in association with the account information of the user who owns the display terminal 40 being parked in the parking section.

Incentive Generation Server 50

The incentive generation server 50 acquires parking lot usage data that is generated on the basis of image data in the parking lot captured by an infrastructure camera 60. The incentive generation server 50 then generates the incentive information on the basis of the parking lot usage data. The incentive information will be described in detail later.

Configuration of Infrastructure Camera 60

The infrastructure camera 60 is a sensor used for observing the inside of the parking lot 30. The infrastructure camera 60 images, for example, parking sections and vehicle paths in the parking lot 30 to acquire image data in the parking lot. The infrastructure camera 60 is a digital camera, a stereo camera, or the like. The image data in the parking lot is digital image data in which a pixel value is defined for each pixel. The installation position and the angle of view of the infrastructure camera 60 are adjusted in advance so that the inside of the parking lot 30 can be imaged. In the present embodiment, multiple infrastructure cameras 60 are provided in the parking lot 30 with different imaging directions.

Configuration of Parking Lot Management System 100

The parking lot management system 100 is a server system for managing the parking lot 30 installed in a facility as a destination set by a user. When the vehicle 20 driven by the user and parked in the parking section is detected, the parking lot management system 100 determines to apply an incentive indicated by the incentive information associated with the parking section to account information of the user of the vehicle 20. The incentive determined to be given is applied to the account information of the user at predetermined timing. The parking lot management system 100 is an example of an information processing device that stores the full/vacancy information indicating a vacant parking section in the parking lot 30 and the account information of the user of the vehicle 20. The parking lot management system 100 includes a reservation information management server 110, an incentive information management server 120, the WEB server 130, a recognition server 140, an incentive application server 150, and a fee adjustment server 160.

Configuration of Reservation Information Management Server 110

The reservation information management server 110 sets the parking section selected through the reception unit 40I of the display terminal 40 as a parking section reserved by the user. Specifically, in the parking lot management system 100, the full/vacancy information is processed by setting the reserved parking section as a parking section that is not vacant, that is, an occupied parking section. For example, the reservation information management server 110 outputs reservation information indicating the selected parking section to the parking lot management system 100. The parking lot management system 100 updates the full/vacancy information on the basis of the reservation information, and stores the updated full/vacancy information in the recognition server 140. In this manner, the parking lot management system 100 sets a parking section as an occupied parking section in the incentive information after receiving the reservation information indicating the relevant parking section selected as the destination. As a result, it is possible to avoid a situation in which the parking section selected by the user is filled with another vehicle and the vehicle 20 cannot park in the parking section.

Configuration of Incentive Information Management Server 120

The incentive information management server 120 manages, via the network, the incentive information associated with a parking section. As illustrated in FIG. 2, the incentive information management server 120 has functions including an incentive temporary determination unit 120A and an incentive determination unit 120B.

The incentive temporary determination unit 120A makes temporary determination that an incentive indicated by the incentive information associated with the parking section reserved by the user is applied to the account information of the user who has made the reservation.

The incentive determination unit 120B determines an incentive to be applied to the account information of the user after the parking is detected. For example, the incentive determination unit 120B may determine to apply, to the account information of the user, the incentive temporarily determined by the incentive temporary determination unit 120A. Alternatively, as a result of updating the incentive information in response to the update of the full/vacancy information, in a case where there is difference between the incentive information associated with the parking section selected at the time of reservation and the incentive information determined to be applied at the time of parking detection, the incentive determination unit 120B may determine that an incentive that is beneficial for the user who has made the reservation is given. Such a beneficial incentive is, for example, an incentive with a larger discount rate of a parking fee, an incentive with a longer extendable parking time, or an incentive with a larger discount rate of a coupon available in a commercial facility provided with the parking lot 30. For example, the incentive determination unit 120B can determine which incentive is beneficial for the user who has made the reservation, in accordance with the priority assigned to each incentive in advance. The priority does not need to be uniform for all users, and may be changed with various user attributes such as usage frequency, age, and user setting. In addition, it is also possible to switch priorities in accordance with a condition of traffic congestion, a day of the week, time of day, and the like. In addition, the number of incentive to be given to the user is not limited to one, and two or more incentives may be given.

Configuration of WEB Server 130

The WEB server 130 provides the display terminal 40 with information from the recognition server 140 via the network. Alternatively, the WEB server 130 acquires information from the display terminal 40.

As illustrated in FIG. 2, the WEB server 130 has functions including a communication unit 130A, a processor 130B, and an accumulation unit 130C.

The communication unit 130A transmits and receives information to and from the recognition server 140 and the display terminal 40. For example, the communication unit 130A transmits the full/vacancy information, the parking lot congestion information, and the incentive information acquired from the recognition server 140 to the display terminal 40 via a known communication line such as a mobile phone network.

The processor 130B processes information transmitted and received by the communication unit 130A.

The accumulation unit 130C accumulates the information acquired by the WEB server 130. In the present embodiment, the accumulation unit 130C accumulates, for example, the full/vacancy information, the parking lot congestion information, and the incentive information.

Configuration of Recognition Server 140

The recognition server 140 updates the full/vacancy information, the parking lot congestion information, and the incentive information in real time to be provided to the WEB server 130. Specifically, the recognition server 140 detects whether or not the parking section is vacant by analyzing the image captured by the infrastructure camera 60 provided in the parking lot 30, and updates the full/vacancy information in real time. Alternatively, the recognition server 140 detects the position of the vehicle 20 traveling on the vehicle path in the parking lot 30 by analyzing the image captured by the infrastructure camera 60 provided in the parking lot 30, and updates the parking lot congestion information in real time. Further, the recognition server 140 updates the incentive information in real time on the basis of the full/vacancy information and the parking lot congestion information.

As illustrated in FIG. 2, the recognition server 140 has functions including a communication unit 140A, a database (DB) unit 140B, an accumulation unit 140C, and a parking detector 140D.

The communication unit 140A transmits and receives information to and from the WEB server 130 and the infrastructure camera 60. For example, the communication unit 140A transmits, to the WEB server 130, the full/vacancy information, the parking lot congestion information, and the incentive information updated in real time via a known communication line such as a mobile phone network.

The DB unit 140B manages information acquired by the recognition server 140.

The accumulation unit 140C accumulates the full/vacancy information, the parking lot congestion information, and the incentive information acquired by the recognition server 140.

The parking detector 140D detects that the vehicle 20 is parked in a parking section. The parking detector 140D detects the parking of the vehicle 20 in a parking section on the basis of, for example, image data of the parking section captured by the infrastructure camera 60. The method for detecting the parking is not limited to the above method. For example, the parking detector 140D may detect the parking by acquiring information on the position of the vehicle 20, which is identified by the navigation device 70 mounted on this vehicle 20.

Incentive Application Server 150

The incentive application server 150 instructs the fee adjustment server 160 to apply the incentive to the account information of the user of the vehicle 20.

Configuration of Fee Adjustment Server 160

The fee adjustment server 160 calculates a parking fee in accordance with a time period from the entry time to the leaving time of the vehicle, and charges the parking fee in association with the account information of the user. In the present embodiment, the exit payment machine installed in the parking lot 30 executes a computer program for implementing various functions of the fee adjustment server 160. Note that a device that executes the program for implementing various functions of the fee adjustment server 160 is not limited to the exit payment machine.

The fee adjustment server 160 applies, to the account information of the user, the incentive which has been determined to be given in the parking lot management system 100. Specifically, for example, the fee adjustment server 160 performs a discount process of a parking fee on the account information of the user in accordance with the determined incentive when the user performs fee adjustment. The account information of the user who performs the fee adjustment may be specified by the input of the account information by the user or the reading of the number of the vehicle, and the method of specifying the account information of the user is not limited thereto.

The fee adjustment server 160 notifies the parking lot management system 100 that the incentive has been applied.

Configuration of Application Notification Unit 170

An application notification unit 170 notifies the display terminal 40 that the incentive determined by the incentive determination unit 120B has been applied to the account information of the user.

Information Acquired by Incentive Granting System 10

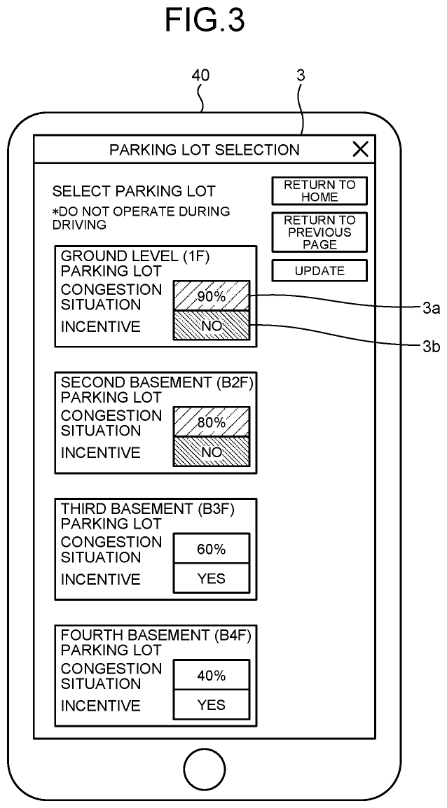

Information used in the incentive granting system 10 will be described with reference to FIGS. 3 to 8.

Full/Vacancy Information

The full/vacancy information is information indicating a vacant parking section in the parking lot 30. In the present embodiment, the recognition server 140 analyzes the image captured by the infrastructure camera 60 provided in the parking lot 30, detects whether or not the parking section is vacant, and the full/vacancy information is updated in real time. Note that the means for acquiring the full/vacancy information is not limited to the infrastructure camera 60, and for example, the full/vacancy information may be acquired using a sensor capable of detecting a vehicle.

In addition, area-specific full/vacancy information indicating, for each area, a full rate that is a ratio of occupied parking sections to all parking sections may be calculated on the basis of the full/vacancy information. The area refers to a place in a given range, which is segmented by a predetermined rule in the parking lot 30. The area is, for example, each layer (or floor) in a parking building.

Parking Lot Congestion Information

The parking lot congestion information is information indicating a congestion state of the vehicle path in the parking lot 30. In the present embodiment, the recognition server 140 analyzes the image captured by the infrastructure camera 60 provided in the parking lot 30. Then, the recognition server 140 detects the position of the vehicle 20 traveling on the vehicle path in the parking lot 30, and thereby the parking lot congestion information is updated in real time. Note that the means for acquiring the parking lot congestion information is not limited to the infrastructure camera 60. The parking lot congestion information may be acquired by using a sensor capable of detecting the vehicle 20. The parking lot congestion information may be acquired on the basis of information on the position of the vehicle 20 identified by the navigation device 70 installed on this vehicle 20.

Incentive Information

The incentive information is information associated with each parking section of the parking lot 30. The incentive information is updated in response to the update of the full/vacancy information. Alternatively, the incentive information may be updated in accordance with a predetermined condition such as a day of the week and time of day.

An incentive in the incentive information to be displayed is, for example, an indication regarding a discount rate of a parking fee, an extendable parking time, or a coupon available in a commercial facility provided with the parking lot 30. The incentive is applied to the account information of the user in accordance with the incentive information associated with the parking section in which the user has parked.

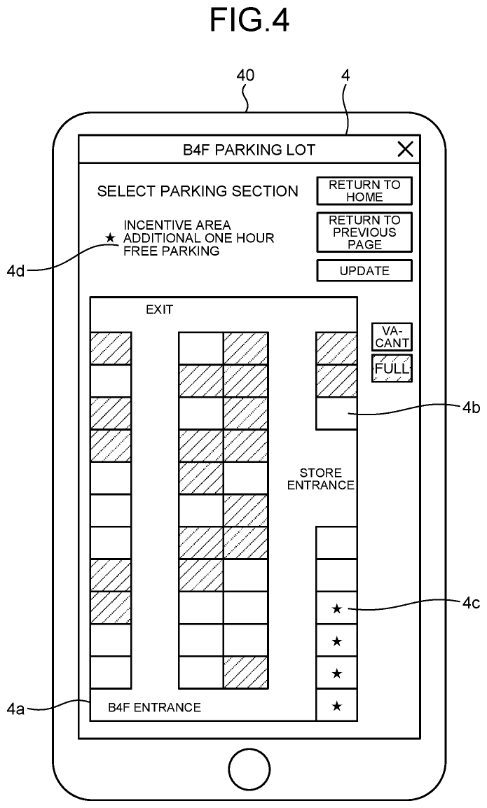

FIGS. 3 and 4 are diagrams each illustrating an example of a display form of incentive information according to the embodiment. As shown in a display image 3 illustrated in FIG. 3, the image of the incentive information includes, for example, an indication 3a of a full rate of each floor of the parking lot 30 and an indication 3b of an incentive. In FIG. 3, the indication 3b of the incentive displays the presence or absence of an incentive using character information, but is not limited thereto. An incentive displayed in the incentive information may be, for example, information regarding a discount rate of a parking fee, an extendable parking time, or a coupon available in a commercial facility provided with the parking lot 30. As shown in a display image 4 illustrated in FIG. 4, the image of the incentive information includes, for example, an indication 4a of the layout of the parking lot 30, an indication 4b of the full/vacancy information of the parking section, an indication 4c of the position of the parking section to which the incentive is applied, and an indication 4d of the incentive. As illustrated in FIG. 4, the indication 4b of the full/vacancy information of the parking section is displayed using, for example, color-coding. In addition, the indication 4c of the position of the parking section to which the incentive is applied is displayed using a predetermined symbol such as a star sign. The indication 4d of the incentive is displayed by using, for example, character information.

After updating the full/vacancy information, the incentive information for an occupied parking section (a parking section that is not vacant) indicated in the latest full/vacancy information may be disabled on the display terminal 40 by deleting an indication of the corresponding incentive information.

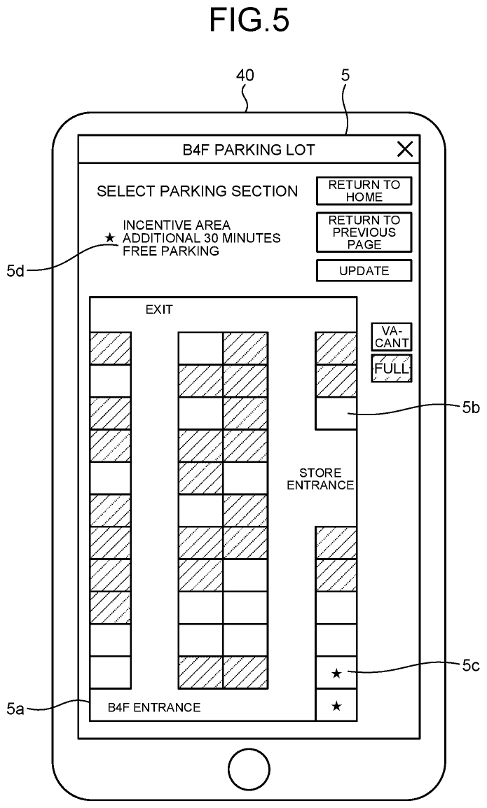

FIG. 5 is a diagram illustrating an example of a display form of updated incentive information according to the embodiment. The image of the updated incentive information includes, as shown in a display image 5 illustrated in FIG. 5, an indication 5a of the layout of the parking lot 30, an indication 5b of the full/vacancy information of the parking section, an indication 5c of the position of the parking section to which the incentive is applied, and an indication 5d of the incentive. In one example, the display terminal 40 switches an image indicating the incentive information from the display image 4 of FIG. 4 to the display image 5 of FIG. 5 in accordance with the update of the incentive information. Specifically, part of the indication 5c of the position of the parking section, to which the incentive is applied, is not displayed in accordance with the update of the incentive information. Additionally, the content of the incentive indicated by the indication 5d of the incentive is changed in accordance with the update of the incentive information.

The content of the incentive information may be changed after updating the full/vacancy information, and the changed incentive information may be displayed on the display terminal 40.

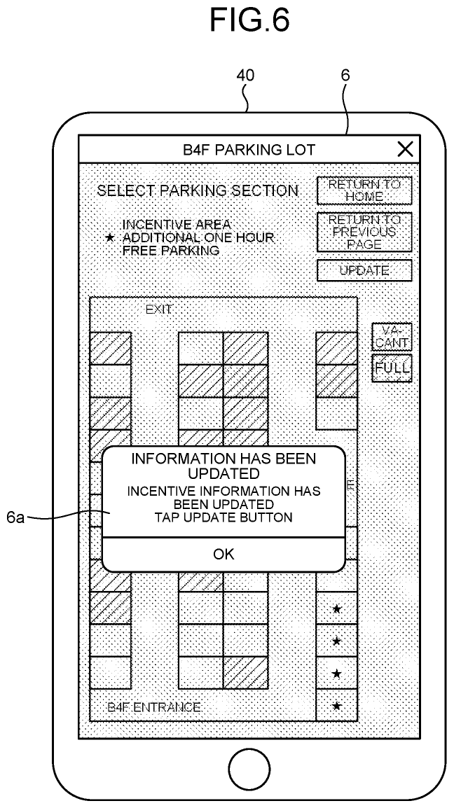

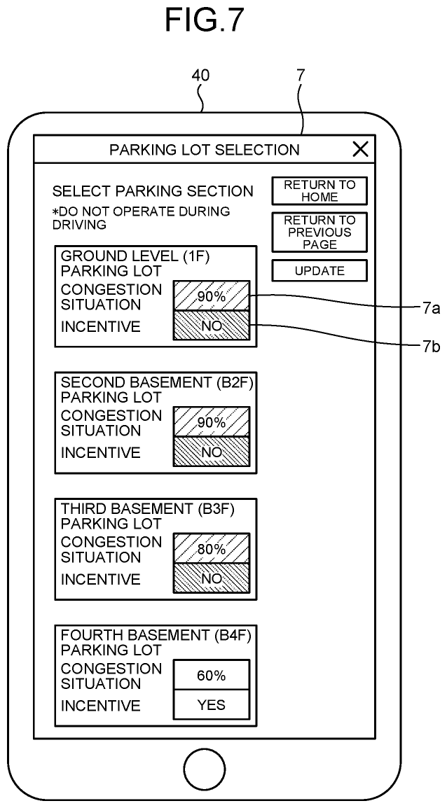

FIGS. 6 and 7 are diagrams illustrating an example of a display form of updated incentive information according to the embodiment. The image of the update of the incentive information includes, for example, an indication 6a of the incentive information update as in a display image 6 illustrated in FIG. 6. The indication 6a of the incentive information update is a display for notifying the user that the incentive information has been updated. That is, the display terminal 40 can also display the display image 6 before switching from the display image 4 to the display image 5. The image indicating the update of the incentive information includes, for example, an indication 7a of a full rate of each floor of the parking lot 30 and an indication 7b of an incentive, as in a display image 7 illustrated in FIG. 7. In one example, the display terminal 40 causes the image to be displayed to transition from the display image 3 of FIG. 3 to the display image 7 of FIG. 7 in accordance with the update of the incentive information. In the update of the incentive information, the indication 7b of the incentive is changed from “with incentive (Yes)” to “without incentive (No)”, for example.

The pieces of the incentive information associated with the multiple parking sections may be displayed on the display terminal 40 to indicate different contents of incentive among those parking sections.

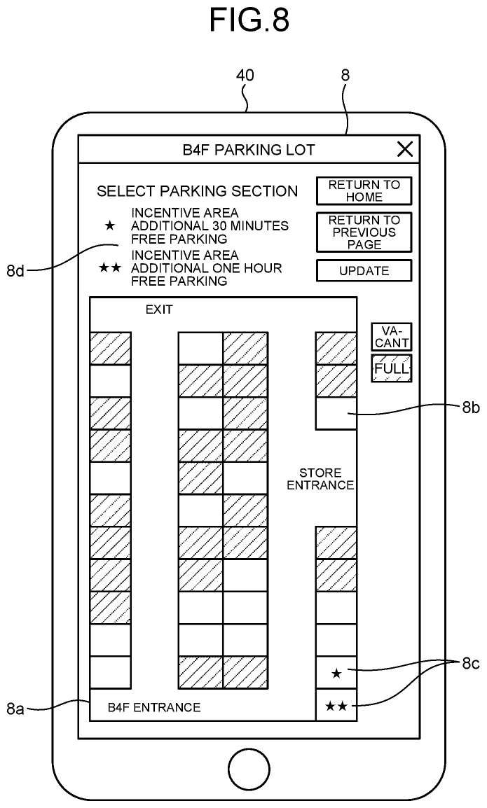

FIG. 8 is a diagram illustrating an example of a display form of pieces of incentive information according to the embodiment. As shown in a display image 8 illustrated in FIG. 8, the image of the incentive information includes, for example, an indication 8a of the layout of the parking lot 30, an indication 8b of the full/vacancy information of the parking section, an indication 8c of the position of the parking section to which the incentive is applied, and an indication 8d of the incentive. The indication 8d of the incentive displays, for example, incentives having different extendable parking times by using character information.

The full/vacancy information may be updated when the use of the parking section is reserved by the user. At that time, the incentive information associated with the reserved parking section may be disabled (that is, not be displayed) on a display terminal of another user.

Procedure of Information Processing of Incentive Granting System 10

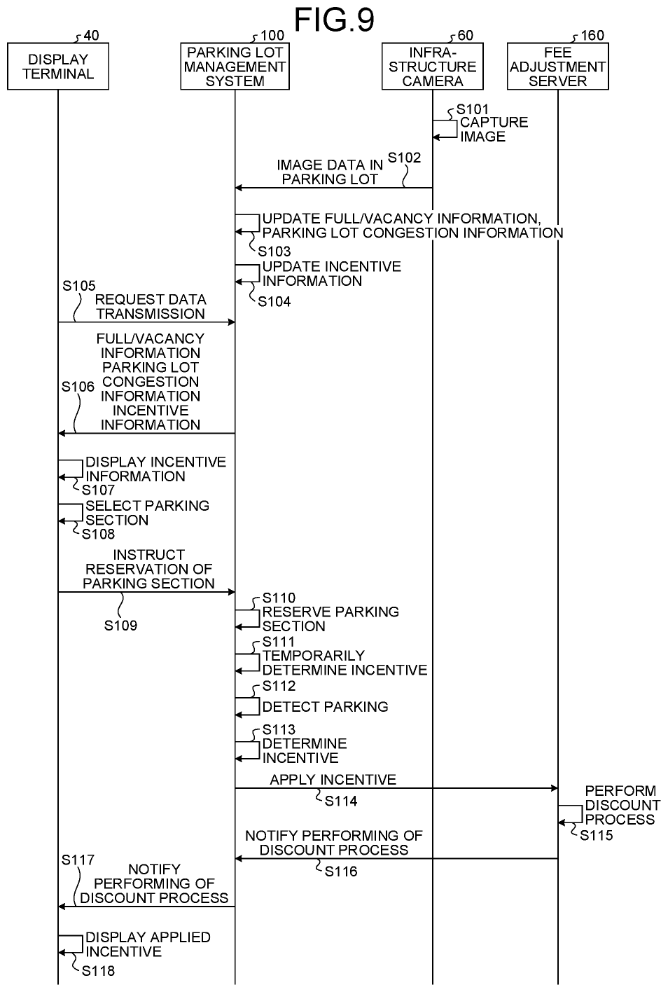

Next, a procedure of information processing executed in the incentive granting system 10 will be described below with reference to FIG. 9. FIG. 9 is a sequence diagram illustrating an example of a procedure of the information processing executed in the incentive granting system 10 according to the embodiment.

The infrastructure camera 60 provided in the parking lot 30 acquires image data of the parking lot obtained by imaging parking sections and vehicle paths in the parking lot 30 (Step S101).

The infrastructure camera 60 outputs image data of the parking lot acquired in Step S101 to the recognition server 140 of the parking lot management system 100 (Step S102).

The parking lot management system 100 updates the full/vacancy information and the parking lot congestion information in real time, and stores the updated full/vacancy information and the parking lot congestion information in the recognition server 140 (Step S103). Specifically, the recognition server 140 analyzes the image data of the parking lot acquired from the infrastructure camera 60 and detects whether or not the parking section is vacant. Then, the recognition server 140 updates the full/vacancy information in real time to be stored in the recognition server 140. Alternatively, the recognition server 140 analyzes the image data of the parking lot acquired from the infrastructure camera 60 and detects the position of the vehicle 20 traveling on the vehicle path in the parking lot 30. Then, the recognition server 140 updates the parking lot congestion information in real time to be stored in the recognition server 140.

The parking lot management system 100 updates the incentive information in real time on the basis of the full/vacancy information and the parking lot congestion information, and stores the updated incentive information in the recognition server 140 (Step S104). Specifically, the recognition server 140 analyzes the full/vacancy information and the parking lot congestion information updated in Step S103, and updates the incentive information associated with each parking section in the parking lot 30 in real time to be stored in the recognition server 140. The incentive information indicates, for example, a parking fee discount, extension of parking time, issuance of a coupon available in a commercial facility provided with the parking lot 30, and the like.

The request unit 40B requests the parking lot management system 100 for the parking lot information including the full/vacancy information, the parking lot congestion information, and the incentive information regarding the parking lot 30 (Step S105).

The acquisition unit 40C acquires the parking lot information including the full/vacancy information, the parking lot congestion information, and the incentive information requested in Step S105 from the WEB server 130 of the parking lot management system 100 (Step S106). Note that the information already stored in the accumulation unit 40H is not acquired from the WEB server 130.

The screen controller 40F displays an image indicating the incentive information acquired from the parking lot management system 100 in Step S106 on the display device of the display terminal 40 (Step S107).

The user selects a parking section to be a destination via the reception unit 40I on the basis of the incentive information displayed in Step S107 (Step S108).

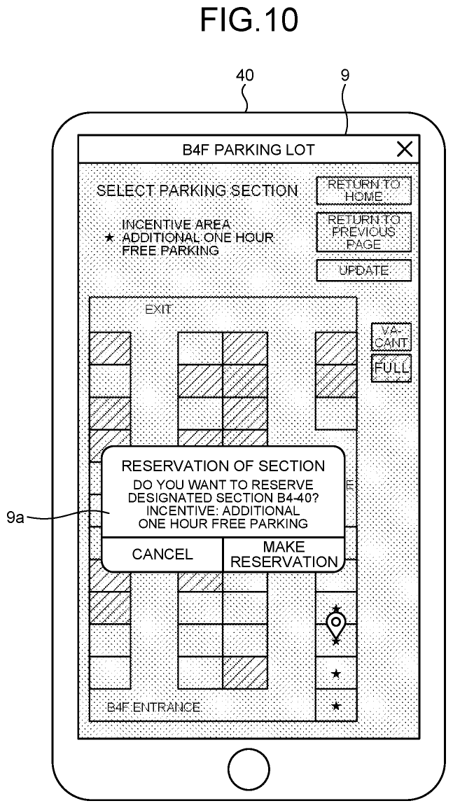

FIG. 10 is a diagram illustrating an example of a display form of information regarding parking section selection according to the embodiment. The information regarding the parking section selection includes, for example, a confirmation indication 9a of the parking section selection as in a display image 9 illustrated in FIG. 10. The confirmation indication 9a of the parking section selection is an indication for confirming to the user whether or not to determine the selected parking section as the destination by using the character information.

Next, the reservation instruction unit 40D transmits, to the parking lot management system 100, an instruction to set the parking section selected in Step S108 as a parking section reserved by the user (Step S109).

The reservation information management server 110 sets the parking section selected in Step S108 as a parking section reserved by the user (Step S110). Specifically, in the parking lot management system 100, the full/vacancy information is processed by setting the reserved parking section as an occupied parking section that is not vacant. For example, the reservation information management server 110 outputs reservation information indicating the selected parking section to the parking lot management system 100. The parking lot management system 100 updates the full/vacancy information on the basis of the reservation information, and stores the updated full/vacancy information in the recognition server 140. In this manner, in the parking lot management system 100, the reservation information indicating the parking section selected as the destination is output, and the selected parking section is set as an occupied parking section in the incentive information. As a result, it is possible to avoid a situation that the parking section selected in Step S108 is used by another vehicle.

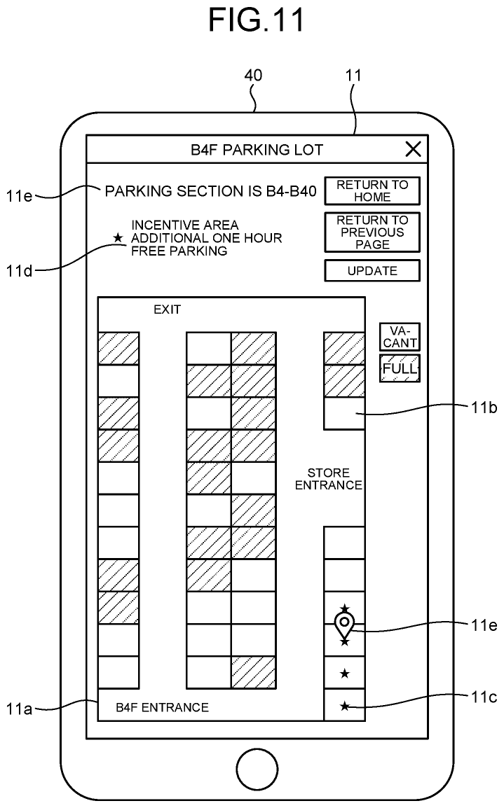

FIG. 11 is a diagram illustrating an example of a display form of incentive information after the parking section reservation according to the embodiment. For example, as in a display image 11 illustrated in FIG. 11, the incentive information after the parking section reservation includes an indication 11a of the layout of the parking lot 30, an indication 11b of the full/vacancy information of the parking section, an indication 11c of the position of the parking section to which the incentive is applied, an indication 11d of the incentive, and an indication 11e of the position of the reserved parking section. The indication 11e of the position of the reserved parking section is displayed using, for example, character information and a predetermined figure.

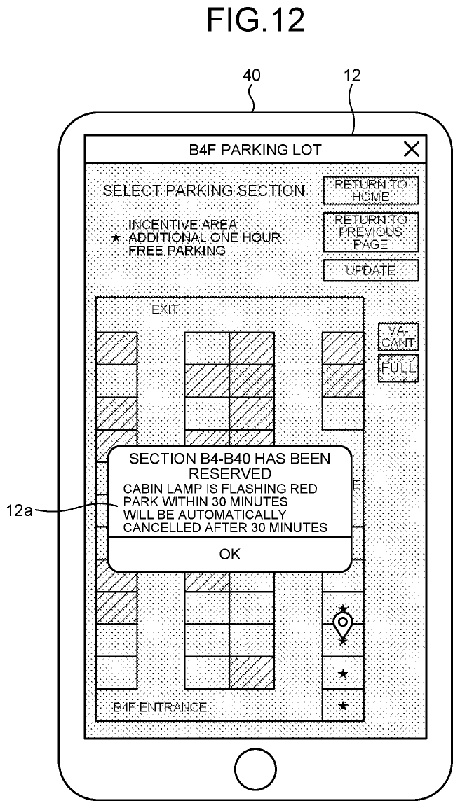

FIG. 12 is a diagram illustrating an example of a display form of information regarding completion of the reservation of the parking section according to the embodiment. As in a display image 12 illustrated in FIG. 12, the information regarding the completion of the reservation of the parking section includes, for example, a reservation completion display 12a of the parking section. In Step S110, the display image 12 of FIG. 12 may be displayed on the display device of the display terminal 40 to notify the user that the selected parking section has been set as the reserved parking section.

The incentive temporary determination unit 120A makes temporary determination that an incentive indicated by the incentive information associated with the parking section reserved in Step S110 is applied to the account information of the user who has made the reservation (Step S111).

The parking detector 140D detects parking of the vehicle 20 in the parking section (Step S112). The parking detector 140D detects the parking of the vehicle 20 in a parking section on the basis of, for example, image data of the parking section captured by the infrastructure camera 60. Note that the method for detecting the parking is not limited to the above method. For example, the position of the vehicle 20 may be specified by the navigation device 70 installed in this vehicle 20, and thereby the parking may be detected.

The incentive determination unit 120B determines an incentive to be applied to the account information of the user after the parking is detected (Step S113). For example, the incentive determination unit 120B may determine to apply the incentive temporarily determined in Step S111 to the account information of the user. Alternatively, after updating the incentive information in response to the update of the full/vacancy information, in a case where there is a difference between the incentive information associated with the parking section selected at the time of reservation and the incentive information determined to be given at the time of parking detection, the incentive determination unit 120B may make determination to give an incentive that is beneficial for the user who has made the reservation.

The incentive application server 150 notifies the fee adjustment server 160 of the incentive determined to be applied to the account information of the user in Step S113 (Step S114).

The fee adjustment server 160 performs a discount process of a parking fee on the account information of the user at the time of the leaving, in accordance with the incentive notified in Step S114 (Step S115). For example, the account information of the user who performs the fee adjustment may be specified by the input of the account information by the user or the reading of the number of the vehicle, and the method of specifying the account information of the user is not limited thereto. In addition, the timing at which the incentive is applied is not limited thereto.

The fee adjustment server 160 notifies the parking lot management system 100 that the incentive has been applied in Step S115 (Step S116).

The application notification unit 170 notifies the display terminal 40 that the incentive has been applied in Step S115 (Step S117).

The screen controller 40F displays information indicating that the incentive has been applied as an image on the display device of the display terminal 40 (Step S118).

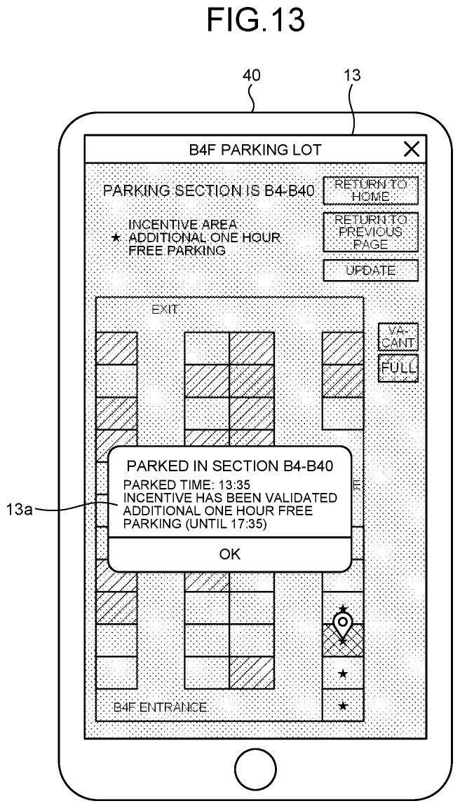

FIG. 13 is a diagram illustrating an example of a display form of information notifying incentive granting according to the embodiment. The information notifying the incentive granting includes, for example, an indication 13a of information indicating that the incentive has been applied as in a display image 13 illustrated in FIG. 13. In Step S118, it is possible to notify the user that the incentive has been given by displaying the display image 13 of FIG. 13 on the display device of the display terminal 40. By an indication in the display image 13, it is also possible to notify the user of the content of the given incentive. In addition, by an indication in the display image 13, it is also possible to notify the user that the parking of the vehicle 20 has been detected. As illustrated in FIG. 13, the notification that the parking of the vehicle 20 is detected can include an indication of the time when the parking is detected.

Note that the information notifying the incentive granting can be displayed at any timing after the incentive granting to the account information of the user is determined in Step S113, and may be displayed in parallel with the discount process in Step S115, for example. In addition, the information notifying the parking detection and the information notifying the incentive granting may be displayed in different display images or may be displayed at different timings. For example, the information notifying the parking detection may be displayed at timing when the parking of the vehicle 20 in the parking section is detected in Step S112 or at timing when the incentive to the account information of the user is determined in Step S113.

Note that the vehicle 20 is not limited to the vehicle driven by the user as long as the vehicle matches the vehicle information registered in association with the account information of the user.

As described above, the incentive granting system 10 according to the present disclosure executes granting of an incentive indicated by the incentive information to a user who uses a parking section associated with the incentive information. In one example, in the incentive granting system 10, pieces of the incentive information associated with multiple parking sections are displayed on the display terminal 40 connected to the parking lot management system 100 via a network.

Therefore, the user can easily recognize the incentive obtained in each of the parking sections in the parking of the vehicle 20. Therefore, by the incentive granting system 10 according to the present disclosure, the user can select an incentive to be applied to the user. In other words, by the incentive granting system 10 according to the present disclosure, it is possible to improve the degree of freedom of the user to select a parking section such that the user can consider a parking section to be parked among parking sections on the basis of the content of the incentive.

In one example, when the vehicle 20 being parked in the parking section associated with the incentive information is detected, the incentive granting system 10 applies an incentive indicated by the incentive information to the user of the vehicle 20 at predetermined timing. In addition, the incentive granting system 10 notifies the user that the incentive has been given. The vehicle 20 is, for example, a vehicle that matches vehicle information registered in association with the account information of the user. In this case, an incentive indicated by the incentive information associated with the parking section is applied to the account information of the user. Giving an incentive to the user means applying the incentive to the account information of the user. Note that the user of the vehicle 20 is not limited to the driver of the vehicle 20, and includes a fellow passenger.

Therefore, it is possible to give an incentive indicated by the incentive information associated with the parking section to the account information of the user in accordance with the full/vacancy situation of the parking lot. In addition, the user can select an incentive indicated by the incentive information associated with the parking section, the incentive being determined in accordance with the full/vacancy situation of the parking lot, and can obtain the selected incentive by parking in the parking section. Therefore, by the incentive granting system 10 according to the present disclosure, by prompting the user to park in a parking section in an area with a low full rate, it is possible to improve the efficiency of parking lot operation by alleviating congestion in the parking lot.

First Modification

In the incentive granting system 10, the navigation device 70 may generate guidance information for guiding the vehicle 20 to a parking section selected as the destination, and may guide the vehicle 20 until it reaches the parking section. In addition, the vehicle 20 may include a parking detector that detects parking operation of the vehicle 20.

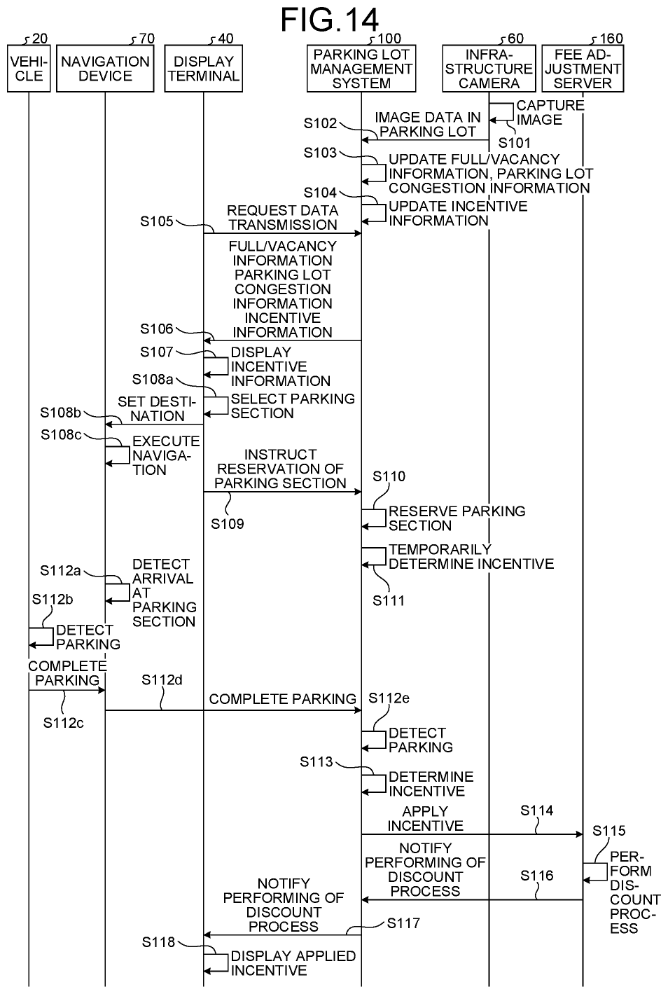

FIG. 14 is a sequence diagram illustrating an example of a procedure of information processing executed in the incentive granting system according to a first modification. Next, a procedure of information processing executed in the first modification will be described below with reference to FIG. 14. Note that the same Steps as those in the above-described embodiment are denoted by the same reference numerals, and detailed description thereof will be omitted.

Similarly to Step S108 of the above-described embodiment, after the parking section is selected in Step S108a, the display terminal 40 transmits an instruction to set the parking section as the destination to the navigation device 70 (Step S108b).

The navigation device 70 generates guidance information to the parking section and executes navigation for guiding the vehicle 20 to the destination (Step S108c). Note that the process in the navigation device 70 is not particularly limited as long as the vehicle 20 can be guided to the set destination.

The navigation device 70 detects arrival of the vehicle 20 at the parking section (Step S112a). For example, the end of the generation of the guidance information up to the parking section is regarded as the arrival at the parking section.

The parking detector of the vehicle 20 detects parking of the vehicle 20 (Step S112b). The parking detector of the vehicle 20 acquires the position of this vehicle 20 by, for example, map matching and detects the parking by detecting that the vehicle 20 has approached the parking section. Alternatively, the parking detector of the vehicle 20 detects the parking by, for example, receiving a signal indicating that the gear is put in the reverse range in the vehicle 20.

The vehicle 20 notifies the navigation device 70 of the completion of the parking (Step S112c). The navigation device 70 notifies the parking lot management system 100 of the completion of the parking (Step S112d). The parking lot management system 100 detects the parking of the vehicle 20 in the parking section in response to the notification of the completion of the parking from the navigation device 70 (Step S112e).

In Step S113 and subsequent Steps, similarly to the above-described embodiment, an incentive to be applied to the account information of the user is determined after the parking is detected, and an image displaying that the determined incentive has been applied is displayed on the display terminal 40.

In the first modification, in addition to the effect of the above-described embodiment, the incentive granting system 10 has an effect that the user can smoothly reach the target parking section.

Second Modification

In the incentive granting system 10, information regarding the incentive determined to be applied to the account information of the user may be displayed on the display device of the display terminal 40. For example, information regarding a coupon available in a commercial facility provided with the parking lot 30 may be displayed on the display device of the display terminal 40.

Third Modification

In the incentive granting system 10, the display terminal 40 may execute a program for implementing various functions of the fee adjustment server 160. As a result, the user can complete the fee adjustment without stopping by the exit payment machine provided in the parking lot.

Fourth Modification

In the incentive granting system 10, automatic parking may be performed by an automated valet parking (AVP) system. In a case where the automatic parking is performed, the vehicle 20 is, for example, a vehicle that matches vehicle information registered in association with the account information of the user. In addition, in a case where the automatic parking is performed, the parking of the vehicle 20 in a parking section is detected at a time point when the user instructs the parking of the vehicle 20.

Fifth Modification

In the incentive granting system 10, selection of a parking section may not be executed by the user. In this case, an incentive indicated by the incentive information associated with the parking section in which parking by the user is detected is applied to the account information of the user. As a result, the user can determine the parking section to be parked in accordance with the situation at the time of arrival at the parking lot 30, and can receive application of the incentive indicated by the incentive information associated with the parking section.

While certain embodiments have been described, these embodiments have been presented by way of example only, and are not intended to limit the scope of the inventions. Indeed, the novel methods and systems described herein may be embodied in a variety of other forms; moreover, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An incentive granting method implemented by a parking lot management system in which full/vacancy information and incentive information are stored, the full/vacancy information indicating a parking section being vacant in a parking lot, the incentive information being associated with the parking section, the incentive granting method being executed to grant an incentive indicated by the incentive information to a user who uses a parking section associated with the incentive information, the incentive granting method comprising:
displaying pieces of incentive information associated with multiple parking sections on a display terminal connected to the parking lot management system via a network;
detecting a vehicle parked in one of the multiple parking sections, the vehicle matching vehicle information registered in association with account information of the user; and
applying, to the account information at predetermined timing, an incentive indicated by one of the pieces of incentive information associated with the one of the multiple parking sections.

2. The incentive granting method according to claim 1, further comprising displaying, on the display terminal, information indicating that the incentive is applied.

3. The incentive granting method according to claim 1, further comprising updating the incentive information associated with the parking section in response to update of the full/vacancy information.

4. The incentive granting method according to claim 3, further comprising disabling, on the display terminal, incentive information associated with an occupied parking section indicated by latest full/vacancy information obtained by the update of the full/vacancy information.

5. The incentive granting method according to claim 3, further comprising
changing content of the incentive information to be update in response to the update of the full/vacancy information, and
displaying, on the display terminal, the incentive information whose content has been changed.

6. The incentive granting method according to claim 1, wherein the pieces of the incentive information associated with the multiple parking sections are displayed on the display terminal to indicate different contents of incentive among the multiple parking sections.

7. The incentive granting method according to claim 1, further comprising, after performing the detecting of a vehicle parked in one of the multiple parking sections,
making determination to perform the applying of the incentive indicated by the incentive information associated with the one of the multiple parking sections to the account information, and
performing, at the predetermined timing, the applying of the incentive to the account information.

8. The incentive granting method according to claim 1, further comprising, when use of the parking section is reserved by a user,
making temporary determination to apply an incentive indicated by incentive information associated with the reserved parking section to account information of the user who has made the reservation,
detecting a vehicle parked in the reserved parking section, the vehicle matching the vehicle information registered in association with the account information of the user who has made the reservation,
making determination to apply the incentive of the temporary determination to the account information, and
applying the incentive to the account information at predetermined timing.

9. The incentive granting method according to claim 8, further comprising, when use of the parking section is reserved by a user,
updating the full/vacancy information, and
disabling, on a display terminal of another user, incentive information associated with the reserved parking section.

10. The incentive granting method according to claim 8, further comprising applying an incentive being beneficial for the user who has made the reservation in a case where incentive information associated with a parking section selected at a time of reservation is different from incentive information determined to be applied at a time of parking detection as a result of updating the incentive information in response to the update of the full/vacancy information.

11. The incentive granting method according to claim 1, wherein
the parking lot management system includes a fee adjustment system to calculate a parking fee in accordance with a time period from entry time to leaving time of a vehicle and charge the parking fee in association with the account information of the user, and
the incentive granting method further comprises performing, at timing of fee adjustment by a user, a discount process of a parking fee associated with account information of the corresponding user in accordance with an incentive determined to be applied.

12. An incentive granting method implemented by a parking lot management system in which full/vacancy information and incentive information are stored, the full/vacancy information indicating a parking section being vacant in a parking lot, the incentive information being associated with the parking section, the incentive granting method being executed to grant an incentive indicated by the incentive information to a user who uses a parking section associated with the incentive information, the incentive granting method comprising:
displaying pieces of incentive information associated with multiple parking sections on a display terminal connected to the parking lot management system via a network;
detecting a vehicle parked in one of the multiple parking sections;
applying, to the user at predetermined timing, an incentive indicated by one of the pieces of the incentive information associated with the one of the multiple parking sections; and
notifying the user of the incentive being applied.

13. A non-transitory computer-readable recording medium on which programmed instructions are recorded, the programmed instructions causing a display terminal with a screen display to execute processing, the display terminal being connected via a network to a parking lot management system in which full/vacancy information and incentive information are stored, the full/vacancy information indicating a parking section being vacant in a parking lot, the incentive information being associated with the parking section, the processing comprising:
acquiring pieces of incentive information associated with multiple parking sections and causing the display terminal to display the pieces of incentive information on the screen display; and
causing the display terminal to display, on the screen display, information indicating that an incentive is applied, the incentive being indicated by one of the pieces of incentive information and being applied by parking a vehicle in a parking section, the vehicle matching vehicle information registered in association with account information of a user who owns the display terminal, the causing being performed when the incentive is applied to the account information at predetermined timing.
